(19) United States
(12) Patent Application Publication
(10) Pub. No.: US 2023/0294784 A1
(43) Pub. Date: Sep. 21, 2023

(54) Support device for backpack on bicycle saddle

(71) Applicant: Christoph Bruno Keist, Wattwil (CH)

(72) Inventor: Christoph Bruno Keist, Wattwil (CH)

(21) Appl. No.: 17/695,917

(22) Filed: Mar. 16, 2022

(51) Int. Cl. B62J 9/26; A45F 3/04

(52) U.S. Cl. CPC B62J 9/26; A45F 3/04

(57) ABSTRACT

The invention relates to a device/product for supporting a backpack while riding as a weight relief for the rider without restriction of freedom of movement on a bicycle or mountain bike. The support is fixed at the bottom of the backpack and then supports on the saddle without a firm connection between the saddle and the support. The device for supporting a backpack is adjustable in height to take into account the individual dimensions of the rider and the backpack. A rigid variant made of plastic/metal is presented as well as a preferred inflatable variant with integrated hand pump.

### TECHNICAL AREA

The present invention relates to a device/product for supporting a backpack on a bicycle or mountain bike while riding as a weight relief for the rider without restriction of freedom of movement.

### PRIOR ART

There are many products available for bicycles, with which you can attach luggage to the bike such as luggage racks or side pockets. As a result, the driver does not have to carry the weight of the luggage himself during the journey. However, the freedom of movement by bike is then restricted, especially off-road with mountain bikes. The luggage also remains on the parked bicycle, which poses a safety risk.

A backpack, on the other hand, allows full freedom of movement on the bike and it can be taken anywhere, even if the bike is parked. The disadvantage is the weight of the backpack which weighs on the back and shoulders of the rider during the whole trip.

WO2029/077618 and U.S. Pat. No. 7,275,787 describe a support device for a backpack on a motorcycle, whereby the support aid is firmly connected to the motorcycle saddle. This is not possible on a bicycle saddle due to lack of space. CN204341334U and CN204279764U describe an adjustable storage plate or carrying basket for a bicycle, which is adjustable in position and height and can thus be adapted to the size and position of the backpack. These 2 solutions have the big disadvantage that with a backpack that does not reach down to the saddle, the device protrudes behind the saddle. This means that the necessary freedom of movement for a cyclist or mountain bike rider is no longer given, especially off-road and downhill where the rider's buttocks have to move backwards to stay centered on the bike. The vast majority of bicycle trucks do not reach down to the saddle.

### SUMMARY OF THE INVENTION

The present invention describes a support device for a backpack on a bicycle or mountain bike to relieve the shoulders of the rider while maintaining full freedom of movement. In the present invention, the backpack is neither attached to the bicycle nor are other devices required on the bicycle.

A backpack has some advantages over fixed bags and boxes. With a backpack, the bike remains fully mobile, which is especially important for mountain bikes. Also, such a bicycle without luggage can be easily lifted over obstacles or loaded into a train, which becomes difficult to impossible with attached luggage. In addition, the luggage is always with the driver, even if the bike is parked, and can be transported comfortably and without any problems. The big disadvantage of a backpack is that the whole load is on the shoulders of the rider, which can be very stressful for the rider, especially on multi-day tours or rides with a lot of weight. The weight is not only on the shoulders, but also the buttocks of the driver are additionally unpleasantly burdened by the weight of the backpack.

An adjustable support plate for a backpack as indicated in the patents mentioned above works for driving on flat roads. But as soon as a gradient of more than 5% has to be mastered, then the rider has to get up centered and safe on the bike and go back with his buttocks. But if the support plate for the backpack protrudes over the saddle, then this is no longer possible. Riding downhill with a mountain bike in steep terrain would become impossible, because the vast majority of bicycle backpacks do not reach down to the saddle by far and thus the storage plate would come very far up. The same applies to fixtures attached to the saddle.

The core of this invention lies in the fact that a height-adjustable support is only attached to the backpack and not to the bicycle. The support takes place directly on the saddle and the rider holds it in position by his own weight (FIG. 1). Thus, the entire support device remains on the backpack and the bike does not undergo any change by devices etc. If the rider is not sitting on the saddle, the device simply hangs down on the backpack and does not affect the rider (FIG. 2). If the rider sits down on the saddle, the support rests on the saddle and lifts the backpack slightly. This relieves the driver's shoulder, back and buttocks (FIG. 1). The length of the support is adjustable and is adapted to the distance between the saddle and the bottom of the backpack, so that the backpack is supported when sitting down but does not stand out too far upwards. The support is fixed on the saddle by the weight of the rider while sitting.

This principle is particularly suitable for bicycles with an upright sitting position with an angle from arms to the upper body of less than 45° up to the position of 90° angle recommended for long tours (FIG. 3). With a very sporty sitting position with an angle greater than 90°, the backpack comes more to rest on the whole back and a support would only take over the relatively small vertical part of the load. In addition, 2 preferred design variants are shown. Variant 1 is based on a rigid construction made of a rigid material such as plastic or metal. Variant 2 works with an inflatable support, which regulates the support force by means of the internal air pressure.

Further embodiments are given in the dependent claims.

### BRIEF EXPLANATION OF THE FIGURES

Preferred embodiments of the invention are described below on the basis of the drawings, which are just for explanation and are not to be interpreted restrictively.

The Drawings Show:

FIG. 1; a cyclist with backpack and support device while riding with weight relief in a sitting position

FIG. 2; a cyclist with backpack and support device while riding without relief in a standing position

FIG. 3; a cyclist (without backpack) in different seating positions

FIG. 4; Simplified representation of a rigid support made of metal or plastic (variant 1)

FIG. 5; Simplified representation of an inflatable support in the inflated state (variant 2)

FIG. 6; Representation of an inflatable support in the non-inflated state (variant 2)

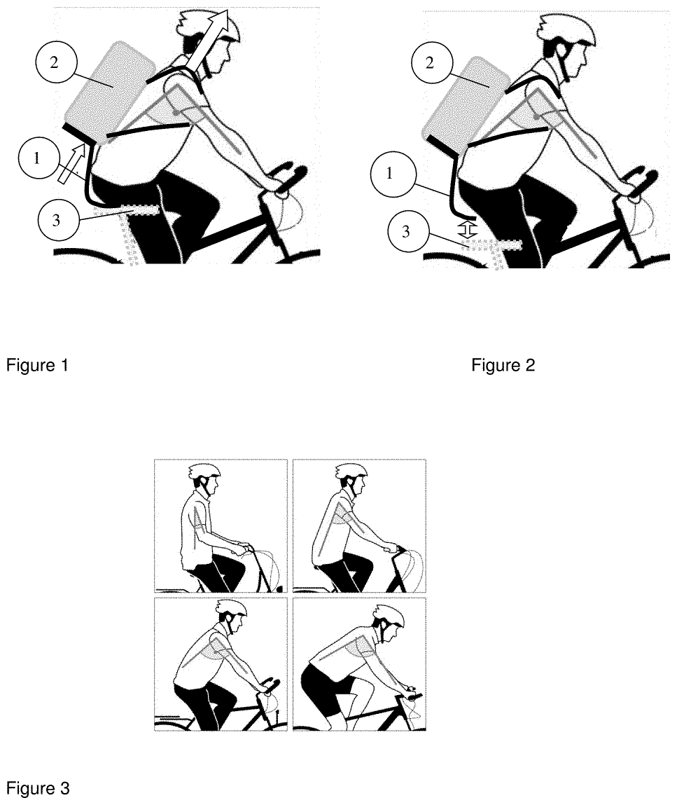

### DESCRIPTION OF PREFERRED EMBODIMENTS

FIG. 4 shows the structure of a stiff support (variant 1) consisting of the support device 1, the backpack 2 and the saddle 3. The support device 1 consists essentially of an upper support 4 and a lower support 5.

The upper support 4 is firmly connected to the backpack 2, wherein the attachment preferably consists of a detachable quick-release system. The variant shown in FIG. 4 shows a plate, which can be easily inserted into the often existing bag for the rain cover of backpack 2 and is thus positioned and attached. But other geometries and fastening forms are also conceivable such as screws, snap fasteners, Velcro, clip fasteners, gluing, plastic welding, sewing, zipper and so on. Depending on the type of attachment and location (bottom or back of the backpack), the upper support is bent or not, so that it runs in a straight or slightly curved line towards the back downwards.

The lower support 5 is adjustable in height and connected to the upper support 4. This adjustable connection 7 can be a simple screw bolt or a latching click system etc. In the lower area, the lower support 5 is bent by 90° and, when the rider sits down on the saddle 3, rests on it. If the rider gets up, then the support device 1 together with the backpack 2 from the saddle 3 lifts off again. The height of the support device 1 must be adjusted before the ride by means of the adjustable connection 7 so that the backpack 2 stands out sufficiently when sitting on the saddle 3 to release the weight via the support 1 on the saddle 2. The distance between backpack bottom 2 and saddle 3 is typically between 10 cm and 40 cm. At the height of the rear end of the saddle 3, a side support 5a is attached to the lower support 5 with advantage, so that the backpack 2 is much more stable on the saddle 3. The side support 5a has a length of 5 cm to 15 cm.

In the area of the saddle, the lower support 5 is a maximum of 3 cm wide and 3 mm thick, so that it does not press the rider on the buttocks. In addition, a textile reinforcement 6 can be attached in the area of the saddle 3 and the lower support 5. This increases the contact surface and thus the clamping effect while driving while sitting. As a result, the support device 1 remains in the correct position and cannot slip backwards. The textile reinforcement 6 can be made of nylon, but also of a thin and soft silicone or TPU etc.

The material of the upper support 4 and lower support 5 can be a light metal such as aluminum or a plastic or composite material with carbon reinforcement. The material thickness is between 1 and 5 mm, depending on the material.

This variant 1 has the disadvantage that in the event of a fall, the support device 1 can cause injuries. Also, this is bulky when the backpack 2 is removed and can not be easily stowed away when not in use. The preferred variant 2 eliminates these disadvantages.

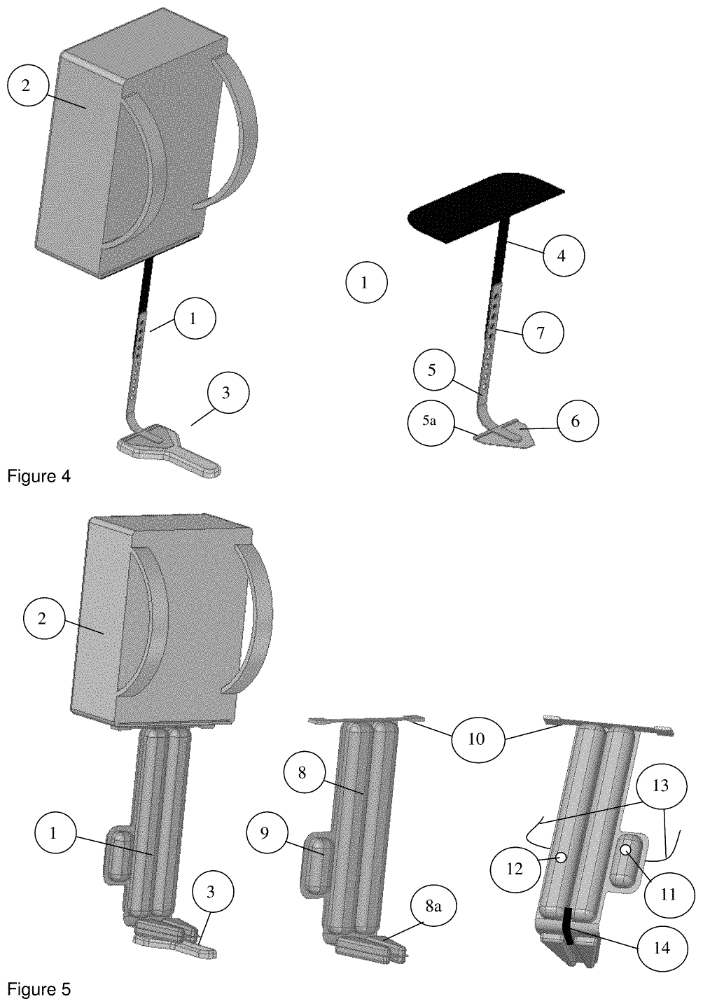

FIG. 5 shows the preferred variant 2 similar to the principle of an air mattress. This inflatable support 8 is soft and small collapsible in the non-inflated state. If it is inflated, then the inflatable support 8 becomes stiff, especially in the longitudinal direction. Such an inflatable support 8 solves the problem with the risk of injury of a stiff support in the event of a fall, the air cushion on the back even has a protective effect. In case of rain, the lower back is also protected from moisture and dirt because mountain bikes in particular are often equipped without a mudguard.

At the top of the inflatable support 8 is a 10-20 mm wide band attached with a fastening system 10. When using the inflatable support 8, this detachable system is connected to a backpack side fastening system 10a that is fixed to the backpack. Preference is given to a common click system as it is already used for backpack carriers and buckles. However, other compounds such as Velcro etc. are also conceivable.

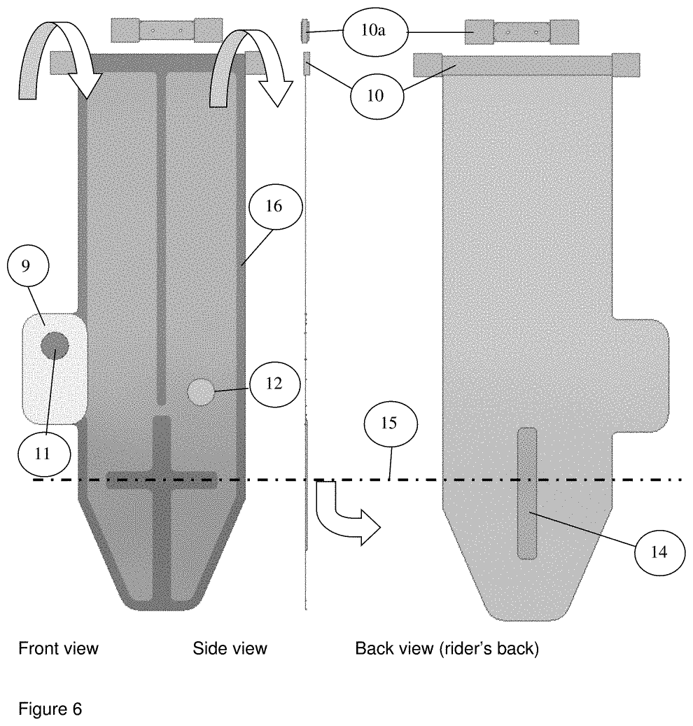

The length of the inflatable support 8 is designed for the maximum size. Before the blow-in support 8 is attached to the backpack, the length must be reduced so that the distance between backpack 2 and saddle 3 is right according to the dimensions of the rider and backpack. This is preferably done by rolling up the inflatable support 8 at the upper end around the band of the fastening system 10, see FIG. 6. As a result, the length can be shortened to the right distance, then the inflatable support 8 on the fastening system backpack side 10a is clicked similar to a drybag or air sofa, except that the inflatable support 8 is a closed system and is clicked before inflating. If the shift is done to the correct side, then the inflatable support 8 is automatically pressed against the driver's back in the inflated state due to the torque generated by the internal pressure and thus fits nicely. However, other systems for shortening the length are also conceivable, for example a sliding temple closure.

The inflatable support 8 consists of one or more interconnected chambers. FIG. 6 shows a preferred structure with a possible layout for weld seam 16. The inflatable support 8 has a width in the inflated state, which corresponds approximately to the saddle width in the range of 5 cm to 15 cm. The thickness is determined by size and number of air chambers and is between 1 cm and 10 cm. The length of the support 8 in the completely rolled out state is between 20 cm and 80 cm.

The inflatable support 8 is a closed air system with at least one inlet valve 11 and one outlet valve 12, which can also be combined in one valve.

Preferably, the air chamber can be inflated via an integrated hand pump 9 and then emptied again via the outlet valve 12. The integrated hand pump 9 works via a second small chamber above the inlet valve 11 with an opening upwards which is closed by hand when pressed. In between, an air-permeable foam is inserted, which resets the pump after actuation. With such a simple integrated hand pump 9, the driver can increase the pressure while driving. He can reduce the pressure via the outlet valve 12, which only has to be pressed in slightly with your finger. In this way, the height of the inflatable support 8 can be optimally adjusted at any time even while driving. The hand pump 9 is preferably located on the left side of the driver at the level of the hip/waist, so that while driving the right hand remains on the handlebars, where the rear brake is also located.

In the lower area of the inflatable support 8, the support is bent by 90°, the seating area 8a then corresponds to the geometry of the saddle. The bending is made possible by the weld seam 16 along the deflection axle 15, which has only 2 small air passages laterally into the seat area 8a of the inflatable support 8. The bending of about 90° is made possible by the bending plate 16. This is pre-bent at a 90° angle and is connected to the weld seam 16 of the inflatable support 8 by gluing, welding or sewing etc. The bending plate 16 is approx. 5 cm to 15 cm long, 5 mm to 20 mm wide and 0.5 mm to 3 mm thick and is made of plastic or metal. The bending radius can range from 1 mm to 10 cm. It is also conceivable that the bending plate 16 is adjustable in angle due to corresponding material properties that allow bending and still be able to maintain the bending position.

After adjusting the length, the inflatable support 8 is inflated and thus becomes a rigid support for the backpack 2. If the rider now sits on the saddle 3 and clamps with his buttocks the seating area 8a of the inflatable support 8 between himself and the saddle 3, then the air in the seat area 8a is displaced backwards and thus the inflatable support 8 made even stiffer and the carrying strap of the backpack 2 stands out pleasantly from the shoulder of the driver. When the driver gets up again, air flows back into the seat area 8a and the inflatable support 8 becomes less stiff, which is pleasant for the wearing comfort, e.B. even during walking passages. The seating area 8a is designed in such a way that there is a weld seam 16 in the middle of the longitudinal axis, to the left and right of each an air cushion, which prevents air from below in the weight of the buttocks from exerting disturbing pressure points while sitting.

For longer descents or in walking passages, some air can be released via the outlet valve 12 for more freedom of movement.

After the ride, the inflatable support 8 can be quickly and easily vented and stored in the backpack in a space-saving manner, in the compartment for the rain cover even without having to be removed.

For better lateral positioning of the inflatable support 8 on the back of the driver, ribbons for belly belt 13 can be attached to the side.

The inflatable support 8 preferably consists of a slightly reinforced fabric, for example 20 D or 75D polyester with a TPU polyether film laminate. However, other materials such as those used for inflatable objects are also conceivable, such as PVC, TPU or coated nylon. The seating area 8a can be additionally reinforced with another layer of material or coating.

### LIST OF DESIGNATIONS

1 Support device
2 Backpack
3 Saddle
4 Upper support
5 Lower support
5a Side support
6 Textile reinforcement
7 Adjustable connection
8 Inflatable support
8a Seat area
9 Integrated hand pump
10 Fastening system
10a Fastening system backpack side
11 Inlet valve
12 Outlet valve
13 Belly belt
14 Bending plate
15 Deflection axle
16 Weld seam

1. Support device 1 for a backpack 2 for weight relief of a cyclist while riding and sitting on the saddle 3, which is attached to the backpack 2 and supports itself on the saddle 3 of the bike and thus slightly lifts the backpack for weight relief while sitting.

2. Support device 1 according to claim 1, characterized in that it consists of a stiff material and is split in an upper support 4 and a lower support 5 which are connected to each other by a height-adjustable connection 7.

3. Support device 1 according to claim 2 characterized in that a textile reinforcement 6 is attached to the lower support 5 in the seating area, which helps that by the weight of the driver the lower support 5 on the saddle 3 is held in position while driving and sitting.

4. Support device 1 according to claim 1, characterized in that it is an inflatable support device 8 with at least one closed air chamber and at least one inlet and outlet valve.

5. Inflatable support device 8 according to claim 4, characterized in that the height of the support device can be adjusted by rolling at the upper end around the ribbon of the fastening system 10 in the non-inflated state.

6. Inflatable support device 8 according to claim 4, characterized in that the fastening to the backpack 2 is carried out with a quick release.

7. Inflatable support device 8 according to claim 4, characterized in that the inlet valve 11 is supplemented by an integrated hand pump 9 that can be operated while driving.

8. Inflatable support device 8 according to claim 4, characterized in that a 90° deflection for the seating area is achieved by a preformed or adjustable bending plate 14 that is attached to the middle weld seam 16.

9. Inflatable support device 8 according to claim 4, characterized in that laterally attached belts create a belly belt 13 that additionally holds the support device in position.

10. Support device 1 according to claims 1 and 4, characterized in that this is integrated directly into a backpack and is firmly connected to it.
